(19) United States
(12) Patent Application Publication
(10) Pub. No.: US 2025/0365244 A1
(43) Pub. Date: Nov. 27, 2025

(54) CARRYING OF CONSTANT BIT RATE SERVICES VIA A FINE GRAIN METRO TRANSPORT NETWORK CHANNEL

(71) Applicant: Microchip Technology Incorporated, Chandler, AZ (US)

(72) Inventors: Steve GORSHE, Beaverton, OR (US); Winston Ki-Cheong MOK, Vancouver (CA)

(21) Appl. No.: 19/090,770

(22) Filed: Mar. 26, 2025

Related U.S. Application Data
(60) Provisional application No. 63/569,727, filed on Mar. 26, 2024.

(51) Int. Cl. H04L 47/25

(52) U.S. Cl. CPC H04L 47/25

(57) ABSTRACT

In some implementations, a first network node may identify a periodic start time of pseudo-ethernet packets based on an available clock. The first network node may receive a client data stream having a constant data rate. The first network node may generate generic mapping procedure (GMP) overhead information based at least in part on the data rate. The first network node may transmit, to a second network node and using the periodic start time, the client data stream within pseudo-ethernet packets that include the GMP overhead information that indicates an amount of information that arrived at the first network node within a period associated with the periodic start time.

### CROSS-REFERENCE TO RELATED APPLICATION

This Patent Application claims priority Provisional Patent Application No. 63/569,727, filed on Mar. 26, 2024, and entitled “CARRYING OF CONSTANT BIT RATE SERVICES VIA A FINE GRAIN METRO TRANSPORT NETWORK CHANNEL” The disclosure of the prior Application is considered part of and is incorporated by reference into this Patent Application.

### FIELD

The present disclosure generally relates to data transmission. More particularly, the present disclosure relates to support for constant bit rate (CBR) clients by mapping CBR client packets to pseudo-Ethernet packets (e.g., a fine-grain CBR payload unit (fgCPU)). The resulting fgCPU may be mapped into fine grain calendar slots (fgCS) of a fine grain multiplex unit (fgMU) as with packets from fine-grain packet clients.

### BACKGROUND

An ITU-T G.8312 metro transport network (MTN) standard specifies carrying ethernet packet streams as 64B/66B-block encoded streams (e.g., as defined in Institute of Electrical and Electronics Engineers (IEEE) 802.3 to encode 64 information or control bits into a 66-bit block format) over sets of 5 gigabit per second (Gb/s) channels. Path overhead is provided through an Ethernet /O/ Ordered set block inserted nominally every k1×16384 blocks, where k1 is the number of 5 Gb/s channels occupied by the client. Support for fine-grain (10 megabits per second (Mb/s)) channelization was added to the MTN standard to support smaller data rates relative to the standard 5 Gb/s rates. Fine grain MTN (fgMTN) supports packet client flows of greater than or equal to 10 Mb/s (e.g., down to a rate that could be produced by a 10MBASE Ethernet interface) scalable in 10 Mb/s increments up to 4.9 Gb/s. The same /O/ block set overhead approach is used with a nominal k2×512 block insertion spacing where k2 is the number of 10 Mb/s channels occupied by the client.

The G.8312 fgMTN specification allows for multiplexing of fine-grain packet streams into channels within payload areas of pseudo-Ethernet packets called fine-grain multiplexing units (fgMU) that are carried as Ethernet packets within an MTN path channel. For example, the fine-grained packet clients may be encoded/transcoded into 64B/66B block streams that are multiplexed into the fgMU payload on a round-robin basis. The fgMU channels into which they are multiplexed form˜10.4 Mb/s fine-grain Calendar Slots (fgCS).

MTN, including fgMTN, is currently defined for carrying Ethernet packet-based clients and does not support CBR clients. Some client signals have tight timing requirements (e.g., jitter/wander) that are relatively complex to meet in Ethernet-based networks, including MTN. A further complication is that although they will share a common time of day (ToD) reference, a source and sink node may have different system reference clocks.

### BRIEF DESCRIPTION OF THE DRAWINGS

FIG. 1 is a diagram of a process flow associated with communication of a constant bit rate (CBR) client signal via an metro transport network (MTN) using pseudo-ethernet packets described herein.

FIG. 2 is a diagram of the nominal overhead block insertion points within a fine grain MTN (fgMTN) stream.

FIG. 3 illustrates a diagram of a structure and content of fine grain MTN (fgMTN) blocks described herein.

FIG. 4 illustrates a diagram of fgMTN blocks described herein.

FIG. 5 illustrates a diagram of fgMTN blocks described herein.

FIG. 6 illustrates a diagram of delivery of a time of day (ToD) and clock frequency and phase reference information described herein.

FIG. 7 illustrates a diagram of fine-grain CBR payload unit (fgCPU) periodic communications described herein.

FIG. 8 illustrates a diagram of fgCPU periodic communications described herein.

FIG. 9 illustrates a diagram of fgCPU periodic communications described herein.

FIG. 10 illustrates a diagram of an fgCPU communication described herein.

FIG. 11 illustrates a diagram of fgCPU overhead format for the periodic communications described herein.

FIG. 12 illustrates a diagram of examples of justification control (JC) bytes carried within an fgCPU described herein.

FIG. 13 is a diagram of example components of one or more devices of FIGS. 1-12.

FIG. 14 is a flowchart of an example process associated with carrying of constant bit rate services via a fine grain metro transport network channel field brief description of the drawings described herein.

### DETAILED DESCRIPTION

The following detailed description of example implementations refers to the accompanying drawings. The same reference numbers in different drawings may identify the same or similar elements.

An ITU-T G.8312 Metro Transport Network (MTN) standard specifies carrying ethernet packet streams as 64B/66B-block (e.g., a fine grain MTN (fgMTN) block) encoded streams over sets of 5 gigabit per second (Gb/s) channels. MTN Path overhead is provided through an Ethernet/O/Ordered set block inserted nominally every k1×16384 blocks, where k1 is the number of 5 Gb/s channels occupied by the client. Support for fine-grain (10 megabits per second (Mb/s)) channelization was added to the MTN standard to support smaller data rates relative to the standard 5 Gb/s rates. FgMTN supports packet client flows of greater than or equal to 10 Mb/s (e.g., down to a rate that could be produced by a 10MBASE Ethernet interface) scalable in 10 Mb/s increments up to 4.9 Gb/s. The same/O/block set overhead approach is used with a nominal k2×512 block insertion spacing where k2 is the number of 10 Mb/s channels occupied by the client.

The G.8312 fgMTN specification allows for multiplexing of fine-grain packet streams into channels within payload areas of pseudo-Ethernet packets called fine-grain multiplexing units (fgMU) that are carried as Ethernet packets within an MTN path channel. For example, the fine-grained packet clients may be encoded/transcoded into 64B/66B block streams that are multiplexed into the fgMU payload on a round-robin basis. The fgMU channels into which they are multiplexed form approximately 10.4 Mb/s fine-grain Calendar Slots (fgCS).

MTN, including fgMTN, is currently defined only for carrying Ethernet packet-based clients and does not support CBR clients. Some client signals have tight timing requirements (e.g., jitter/wander) that are relatively complex to meet in Ethernet-based networks, including MTN. A further complication is that although they will share a common time of day (ToD) reference, a source and sink node may have different system reference clocks.

In some aspects described herein, a first network node may receive a ToD synchronization message and identify a periodic start time of pseudo-ethernet packets (PEPs) based on an available clock. The first network node may receive a client data stream having a data rate and generate generic mapping procedure (GMP) overhead information based at least in part on the data rate. The first network node may transmit, to a second network node and using the periodic start time, the client data stream within pseudo-ethernet packets (e.g., fgCPU) that include the GMP overhead information that indicates an amount of information that arrived at the first network node within a period associated with the periodic start time.

For example, a network node may map CBR client payloads into pseudo-Ethernet packets referred to as a fine-grain CBR payload unit (fgCPU). The client payload area of the fgCPU may include a combination of payload bytes of the set of 64B/66B data blocks (/D/) and the /T/ block. The resulting fgCPUs may be mapped into fgCSs of the fgMU in the same manner as packets from fine-grain packet clients. This may allow a normal ethernet idle insertion/removal procedure (IMP) rate adaptation within the fgCS. The client information may be inserted into the fgCPU payload area using an ITU-T G.709 GMP. GMP may allow a fixed size for the fgCPU that is optimized for improved bandwidth efficiency within a constraint of having an fgMTN /O/ block every k2×512 channel blocks independent of a client rate relative to the fgCS channel rate. Further, GMP allows subdividing the fgCPU payload area to carry multiple lower rate (e.g., 2 Mb/s) clients within the same stream of fgCPU packets.

In some aspects, the source and sink nodes may share a common ToD reference. In some aspects, the source and sink nodes may not necessarily share a common system or network reference clock. In some aspects, the source and sink nodes may share a common network reference clock. The fgCPU packets may be transmitted by the source node (i.e., inserted into the fgCS) on a fixed interval that is known by the sink node. A time interval may be used with the common ToD scenario and the time interval may be based at least in part on a fixed number of fgCS bits for scenarios with a shared common network reference clock. The known fixed interval provides the sink node a timing base for recovering a CBR client signal clock and performing jitter/wander filtering.

Based at least in part on using a common ToD reference and mapping CBR data to pseudo-ethernet packets using the common ToD reference between nodes, the source node and the sink node may communicate the CBR data with improved efficiency and improved latency.

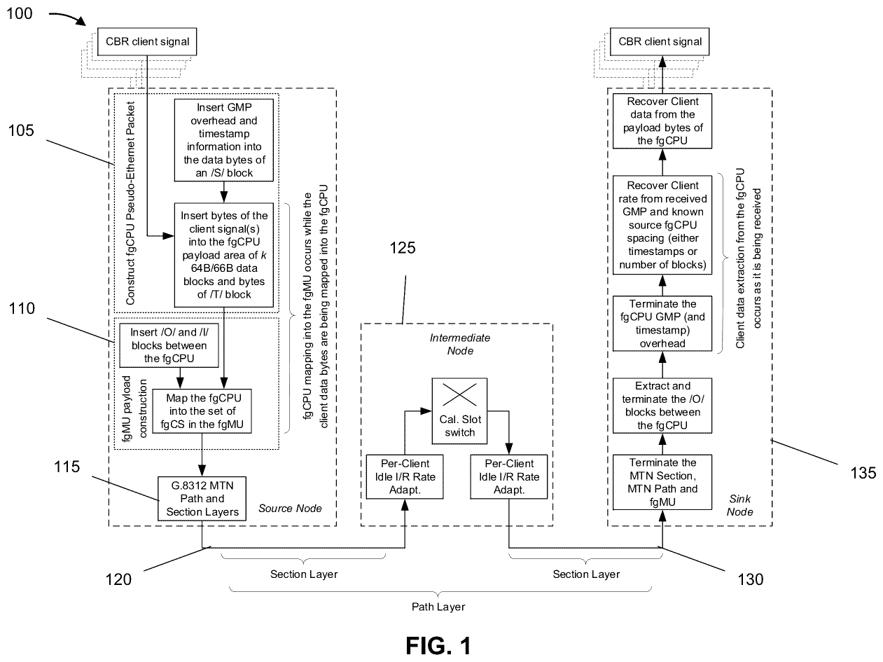

FIG. 1 is a diagram of a process flow associated with communication of a CBR client signal via an MTN using pseudo-ethernet packets described herein. As shown in FIG. 1, and by reference number 105, a first network node (e.g., a source node) may construct an fgCPU pseudo-ethernet packet. The first network node may receive a CBR client signal from a client device for communication (e.g., via a direct connection to a client). The first network node may insert GMP overhead and timestamp information into data bytes of an /S/ block (a control block type associated with 64B-66B control blocks that indicates a start of an ethernet packet) of the pseudo-ethernet packet. The first network node may also insert bytes of one or more client signals into an fgCPU payload area of k 64B/66B data blocks and bytes of one or more /T/ blocks (a control block type associated with 64N-66B control blocks that indicates a termination or end of an ethernet packet).

As shown by reference number 110, the first network node may perform fgMU payload construction. For example, the first network node may insert /O/ and /I/ blocks between the fgCPU. The /I/ block is an Idle block used in a gap between Ethernet packets. An /O/ block is used to communicate Ethernet link control information. MTN and fgMTN use a special version of the /O/ block for control and monitoring overhead. The first network node may map the fgCPU into a set of fgCS in the fgMU.

In some aspects, in connection with reference number 105 and 110, fgCPU mapping into the fgMU may occur while the client data bytes are being mapped into the fgCPU.

As shown by reference number 115, the first network node may provide the mapped fgCPU on an MTN path and section layers (e.g., G.8312 MTN path and section layers). As shown by reference number 120, the first network node may provide the pseudo-ethernet packets via an MTN path via a section layer to one or more intermediate nodes.

As shown by reference number 125, an intermediate node may perform one or more operations associated with forwarding the fgCPU packet. For example, the intermediate node may perform a per-client idle I/R rate adaptation, a cal. slot switch, or another per-client idle I/R rate adaptation. As shown by reference number 130, the intermediate node may forward the fgCPU packet via the MTN on a section layer.

As shown by reference number 135, a second network node (e.g., a sink node) may perform one or more operations associated with receiving the fgCPU packet. For example, the second network node may terminate the MTN section, MTN path, and fgMU. The second network node may extract and terminate the /O/ blocks between the fgCPU. The second network node may perform client data extraction from the fgCPU as it is received. For example, the second network node may terminate the fgCPU GMP (and timestamp overhead) and recover a client rate from the received GMP and known source fgCPU spacing (e.g., timestamps or a number of blocks). The second network node may recover client data from the payload byte of the fgCPU. The second network node may then forward the CBR client signal.

As shown in FIG. 1, a network node (e.g., an intermediate node) may receive a client data stream from a source node (e.g., directly or via an additional intermediate network node connected to the source node). The network node may receive the client data stream with a first data rate. The network node may perform one or more operation on the client data stream (e.g., reading GMP overhead information) before transmitting the client data stream to a sink node (e.g., directly or via an additional intermediate network node connected to the sink node).

An fgMTN source node (e.g., an ingress node) may generate the GMP information of the client data stream based at least in part on the data rate of the client data stream that enters the fgMTN, as described herein. Additionally, or alternatively, the network node may include GMP overhead information that indicates an amount of information that arrived at the network node within a period of time (e.g., a period that is based at least in part on a periodicity of start times for pseudo-ethernet packets associated with the client data stream). In some aspects, the network node may adapt a data rate of the client data stream.

The number and arrangement of components shown in FIG. 1 are provided as an example.

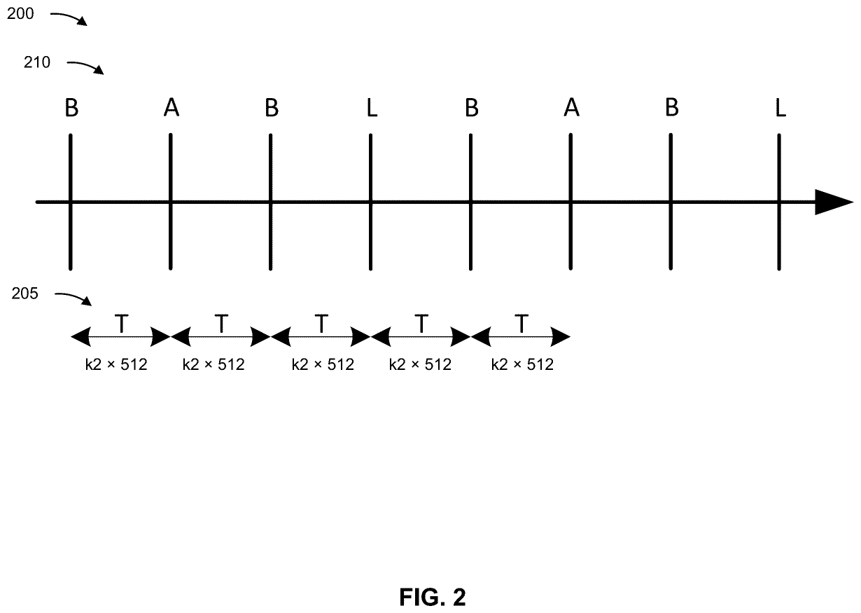

FIG. 2 is a diagram of a periodicity T of fgMTN blocks (e.g., 64B/66B blocks) described herein. As shown in FIG. 2, nominal spacing 205 between fgMTN /O/ blocks may be k2×512 (k2×512) blocks 210 where k2 is a number of 10 Mb/s fgCS channels occupied by a client. The different block types described in the figures of this disclosure pertain to the ITU G.8312 Metro Transport Network (MTN) standard. Block types, such as B, A and L blocks are as defined in the specification of the ITU G.8312 MTN standard. The different block types relate to different types of information carried in the MTN /O/ blocks.

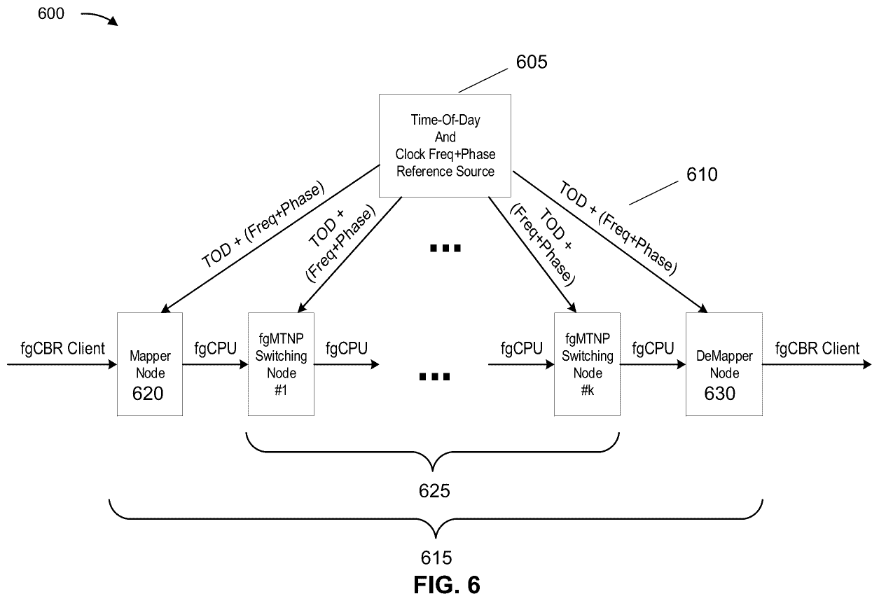

In some aspects, a network node may identify a periodic start time of the blocks (pseudo-ethernet packet) shown in FIG. 2 based at least in part on an available clock. The periodic start time has a period equal to the nominal spacing 205. The available clock may be a clock that is local to the network node, or may associated with a different network node that is accessible to the network node via one or more network connections, or from an external reference clock input (e.g., a global positioning signal or global navigation satellite system signal, among other examples). For example, as shown in FIG. 6, network nodes (e.g., switching nodes) may receive a clock signal as a time-of-day+frequency and phase signal from a time-of-day and clock frequency and phase reference source.

The number and arrangement of components shown in FIG. 2 are provided as an example.

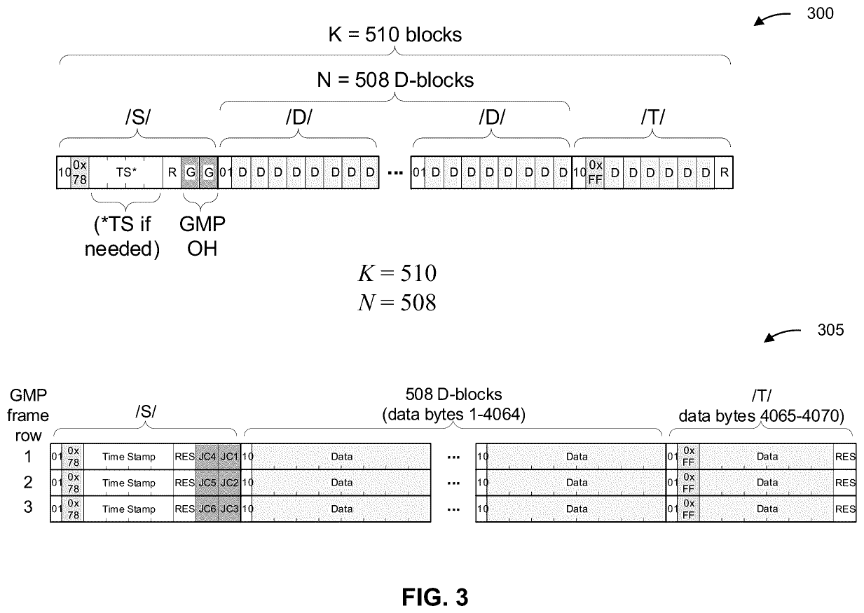

FIG. 3 illustrates a diagram of a structure and content of an fgCPU (e.g., a 64B/66B block) described herein. The fgCPU 300 may include a 64B/66B block structure associated with information or control bits carried in an ethernet packet stream. The fgCPU block 300 begins with a 2-bit synchronization header. A data (D) block contains 8 client data bytes. As shown in FIG. 3, 508 D blocks are preceded by an /S/ block (start block) and followed by a T block (termination block).

As shown in FIG. 3, a size of an fgCPU 300 may include K (510) blocks, including the /S/ and /T/ blocks. This supports insertion of both an /O/ and an /I/ idle block between pairs of fgCPUs. In the worst-case scenario where a device occupies a single fgCS, this allows for satisfaction of both the /O/ spacing and the availability of enough /I/ blocks to support IMP along the fgMTN path with minimum buffering at intermediate nodes. The client data is carried within the data bytes of the /D/ and /T/ blocks of the fgCPU 300, assuming a T7 /T/ block. A T7 /T/ block is a /T/ block that includes 7 bytes of client information before a terminate control code. In some aspects described herein, the 7 bytes may be used to carry information other than client data.

As shown in FIG. 3, the /S /block, which has a 0×78 control block type code (a hexadecimal value corresponding to the /S/ control block), may include an overhead byte, a time stamp if needed, a reserve byte, and two GMP overhead bytes (GMP OH). The /D/ blocks may include data bytes and an overhead byte. The /T/ blocks may include an 0×FF byte (corresponding to a T7 control block), data bytes, and a reserve byte.

As further shown, the fgCPU 300 includes 508 /D/ blocks, an /S/ block, and a /T/ block for a total of N=508 blocks. The/S/block may include per-fgCPU overhead. In some aspects, ethernet may process only the/S/byte fields in the layer above a physical coding sublayer (PCS). Because fgMTN processes occur within the PCS, these bytes will likely not be touched by ethernet processes and hence are available for use in the MTN. Using the /S/ block for overhead improves the fgCPU overall bandwidth efficiency. Further, placing the GMP overhead in the /S/ block improves an amount of time available for a sink node to determine a Cm value associated with the next GMP window.

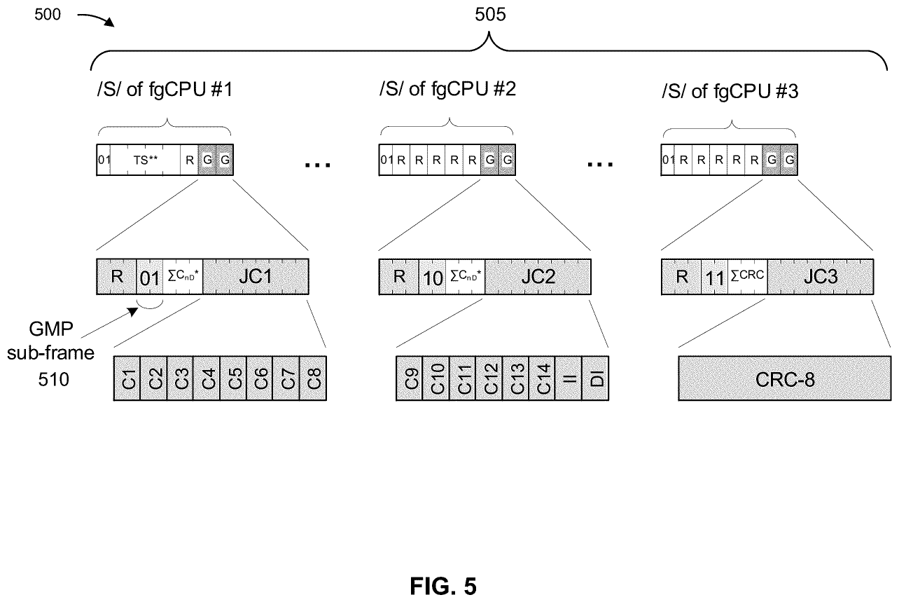

Also, timestamps are traditionally sent at the beginning of a packet. Note that if timestamp information is sent in each fgCPU, the worst-case (e.g., single fgCS) period between the timestamp is˜3.2 ms. Consequently, only the increment between successive ToD values need to be transmitted. Further, the 3.2 ms nominal interval may be encoded by the three least significant bytes of an IEEE 1588 field associated with nano-second resolution. This is shown in FIG. 3 (and in FIG. 5 referenced below), which show that there is room for a fourth timestamp byte if desired.

As shown by reference number 305, the fgCPU 300 may include multiple GMP frame rows that include the/S/block, the 508 /D/ blocks, and the /T/ block. FIG. 3 shows a higher level view of the fgCPU 300, while 305 shows how the GMP justification control (JC) bytes in the /S/ block are different in each of the three rows. For example, JC4 and JC1 in the first row, may be different. Specific JC byte fields for each of the three rows is shown in FIG. 5, described below.

The number and arrangement of components shown in FIG. 3 are provided as an example.

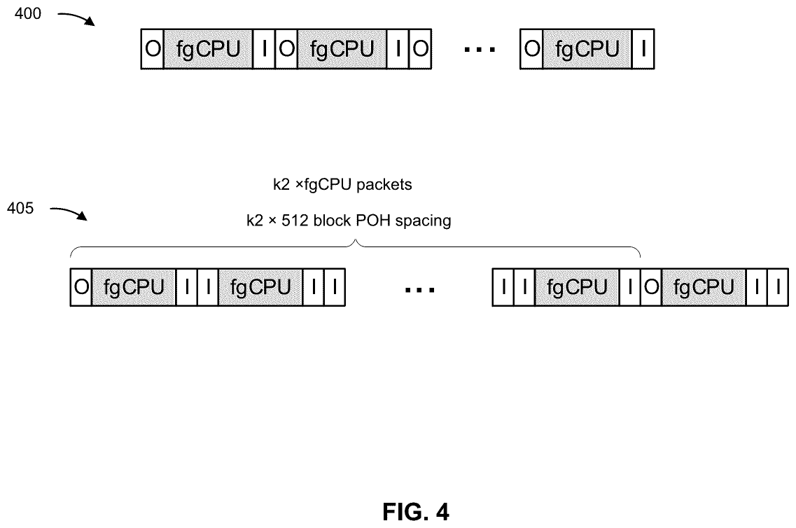

FIG. 4 illustrates a diagram 400 of fgMTN blocks described herein. FIG. 4 illustrates a block stream in terms of the fgCPU packets and what blocks go between fgCPU packets. If the client intends to use a single fgCS channel, as in diagram 400, then an fgMTN block may use one /I/ block and one /O/ between each pair of 510-block-long fgCPUs. This satisfies a general need for at least one /I/ block between packets and satisfies a protocol shown in FIG. 2 for an /O/ block every 512 blocks.

Diagram 405 shows an example where a client uses more than one fgCS channel. The /O/ block spacing is the same time interval regardless of how many fgCSs are being combined. For example, if a client occupies 2 fgCSs, then the channel has twice the rate and the /O/ would be sent half as often. More generally, if k2 (indicating spacing between /O/ blocks, as described in connection with FIG. 2) fgCS are being used, then the /O /is sent 1/k2 as often, hence the k2*512 block spacing between /O/s in 405. In order to maintain the same spacing between fgCPUs, an extra /I/ may be sent in 405 when it is not an appropriate time to send an /O/.

Each fgCPU comprises k blocks (e.g., as shown in FIG. 3) where, per FIG. 3, k=510 may be an example. K blocks (an fgCPU length) of an fgMTN packet (e.g., fgCPU packet) may include an /O/ block before each fgCPU block, and an /I/ block after each fgCPU block, with the /O/ block and the /I/block being idle blocks (e.g., inter-packet Ethernet Idle blocks) that separate pairs of fgCPUs.

Diagram 405 of fgMTN blocks (e.g., fgCPU blocks) shows that k blocks of an fgMTN packet may include an /O/ block before a first fgMTN block, an /I/ block after the first fgMTN block, /I/ blocks before and after each of the middle fgMTN blocks, an /O/ block before a last fgMTN block, and at least one /I/ block after the last fgMTN block.

The number and arrangement of components shown in FIG. 4 are provided as an example.

FIG. 5 illustrates a diagram 500 of fgMTN blocks described herein. As shown in FIG. 5, /S/ blocks 505 of a series of fgCPUs may include information associated with forwarding the fgCPU through the MTN. The /S/ blocks 505 may include two GMP overhead (“G”) bytes that included bits of information. For example, the two G bytes may include three reserve bits, two bits for indicating a GMP sub-frame 510 (e.g., an index), and justification control (JC) bits.

The number and arrangement of components shown in FIG. 5 are provided as an example.

The fgCPU format using /T/ block bytes for payload and the /S/ for overhead allows carrying a bit-transparent 10MBASE Ethernet client within a single fgCS and a 100MBASE Ethernet client in 10 fgCS. Using the /T/ or a /D/ block for overhead would result in using an additional fgCS for both clients.

In some aspects, the only timing reference shared by both the fgMTN source and sink nodes is a global ToD. The global ToD may be provided directly from a GPS/GNSS satellite receiver source or distributed through the MTN using a Precision Timing Protocol (PTP) such as IEEE 1588.

FIG. 6 illustrates a diagram 600 of delivery of a ToD and clock frequency and phase reference information described herein. As shown in FIG. 6, network nodes (e.g., switching nodes) may receive a clock signal from an available clock that is associated with a time-of-day and clock frequency and phase reference source 605. The clock signal may be a time-of-day+frequency+phase signal 610.

As shown in FIG. 6, an MTN may be associated with a ToD and clock frequency and phase reference source (ToD source) 605. The ToD source may provide clock information, including ToD and clock frequency and phase information 610 to network nodes 615 of the MTN. In this way, a network node may receive a clock signal from an available clock that is associated with a time-of-day and clock frequency and phase reference source 605.

The network nodes 615 of the MTN may include a mapper node 620 (e.g., a source node), one or more fgMTN switching nodes 625, and a demapper node 630 (e.g., a sink node).

As shown in FIG. 6, the network nodes 615 may receive data from an fgCBR client (e.g., at the mapper node). The mapper node 620 may forward the data through the MTN via the one or more fgMTN switching nodes 625 to the demapper node 630. The demapper node 630 may provide the data outside of the MTN network after demapping.

The number and arrangement of components shown in FIG. 6 are provided as an example.

The described techniques for communicating the CBR data through an MTN using fgMTN mapping of the pseudo-ethernet packets (e.g., CBR data) can be used with multiple clock sources available at the source node for generating the fgCPU. For example, a clock source may be a clock derived from the global ToD reference, a clock derived from the network clock (e.g., derived from an ingress SyncE interface and used to time the MTN egress interfaces), or a clock derived from the recovered ingress client clock rate, among other examples.

GMP has been demonstrated in time division multiplexing (TDM) applications such as an optical transport network (OTN) to provide suitable CBR client timing transparency. For example, using GMP to map client information into the fgCPU also improves latency at both the source node and the sink node. As with TDM signals that use GMP, the information can be inserted into the fgCPU payload area as it is being transmitted rather than buffering an entire fgCPU prior to transmission. Similarly, at the receiver, the client information can be extracted as the fgCPU is being received rather than waiting for receipt of an entire fgCPU prior to client information extraction. In other words, both source insertion and sink extraction occur “on the fly” so that client ingress and egress first-in-first-out (FIFO) size is improved. Additional advantages of using GMP may include allowing a fixed fgCPU size independent of client rate, which simplifies frame, overhead, and timing information recovery. Additionally, bit or sub-bit level timing accuracy regarding the amount of client data arriving in the time interval may be improved. Further, using GMP may improve flexibility for adding new CBR client signal types, provide a straightforward way to subdivide the fgCS to allow multiple lower rate client signals (e.g., E1 signals) to share the same fgCS, or offloading the task of determining an amount of client data arriving in the interval sink to the source, which can communicate the amount of client data directly to the sink in the GMP overhead.

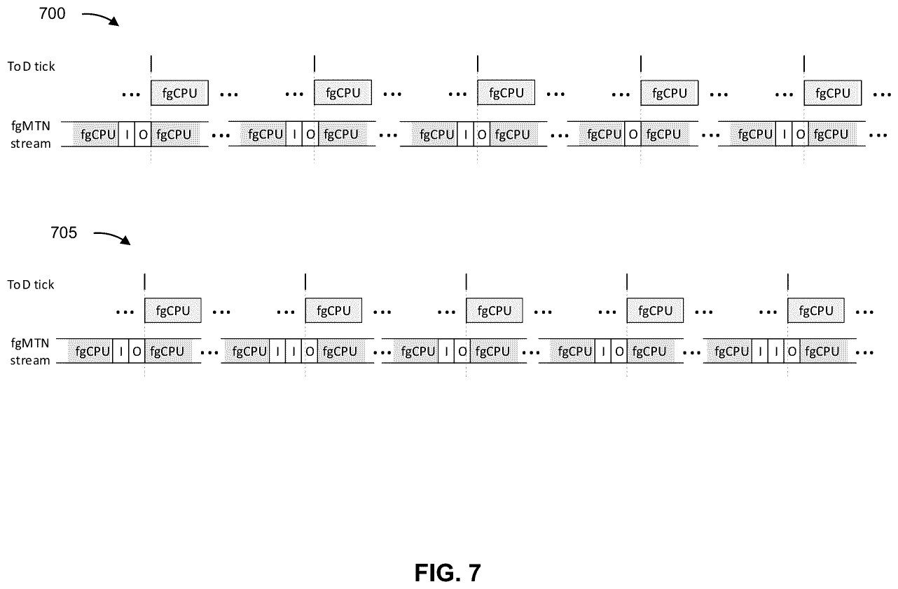

FIG. 7 illustrates a diagram 700 of fgCPU periodic communications described herein. For a scenario where the fgCPU is generated with a clock derived from the global ToD reference, the source node may use a fixed ToD interval between the starting point (e.g., a periodic start time), identified based at least in part on an available clock, for generating each fgCPU. The fgCPU transmission begins at the next opportunity within the fgMTN stream after its generation begins. As illustrated in FIG. 7, the source node may occasionally add or remove an /I/ block to accommodate a difference between the ToD interval and the network clock. Since the sink node has the same ToD reference and already knows the source fgCPU generation interval, the sink node can accurately determine the client timing without sending timestamps. The received GMP overhead communicates to the sink node the amount of client data that arrived at the source during the ToD interval.

The number and arrangement of components shown in FIG. 7 are provided as an example.

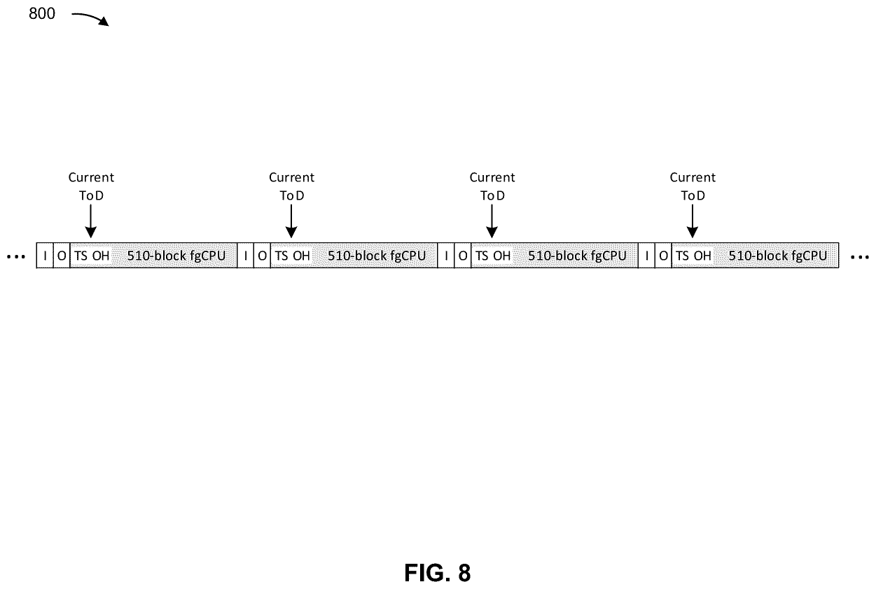

FIG. 8 illustrates a diagram 800 of fgCPU periodic communications described herein. For the scenario where the fgCPU is generated with a clock derived from the network clock, the source node may use a fixed number of fgCS blocks between the start of each transmitted fgCPU and a fixed number of /I/ blocks between each fgCPU. Because of a small offset between the ToD interval and block count interval, the source node may send an explicit timestamp associated with the fgCPU generation time. The sink node may use the timestamp difference between successive fgCPUs to determine the client rate (e.g., a data rate of a client data stream). The received GMP overhead may directly inform the sink node about the amount of client information that arrived at the source during the fgCPU generation period (e.g., ToD interval).

The number and arrangement of components shown in FIG. 8 are provided as an example.

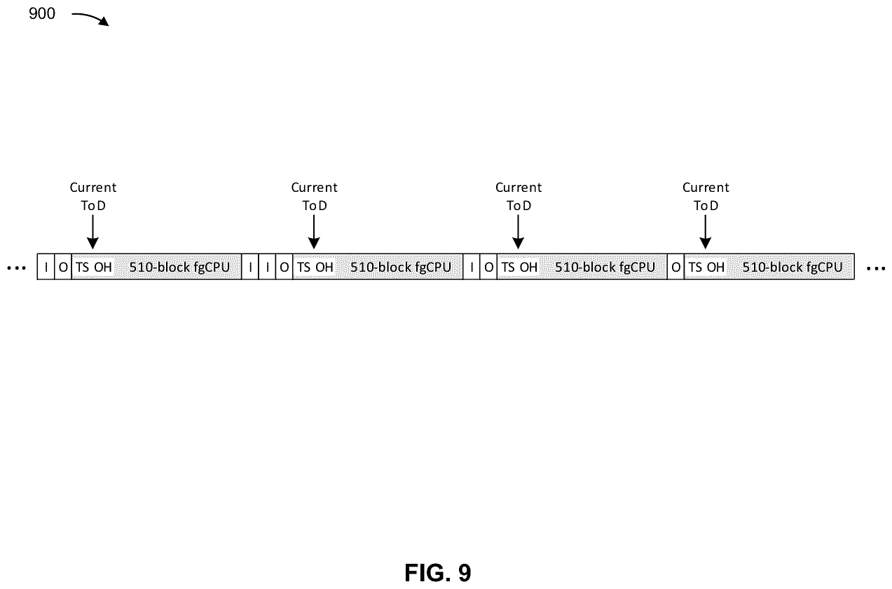

FIG. 9 illustrates a diagram 900 of fgCPU periodic communications described herein. For a scenario where the fgCPU is generated with a periodic start time that is based at least in part on a clock derived from a recovered ingress client clock rate, the source node may generate the fixed-length fgCPU using a clock derived from the ingress client signal, which may result in a fixed (e.g., pre-determined) amount of client data in each fgCPU (e.g., a data rate of the fgCPU). In this way, a fixed value or pattern may be used for the GMP overhead. As illustrated in FIG. 9, the source node may occasionally add or remove an /I/ block to accommodate a difference between the ToD interval and the client-derived clock. As with the scenario described in connection with FIG. 8, the source may send an explicit timestamp associated with the fgCPU generation time. The sink node may use the timestamp differences between fgCPUs and knowledge of the fixed amount of client information per fgCPU to determine the client rate.

In some aspects, a network node (e.g., source node) may determine a periodic start time based at least in part on receiving a desired new amount of client data. The network node generates a fixed value for GMP overhead that indicates the desired amount of data for the fgCPU

Once a network node has constructed a client data stream of blocks shown in FIG. 9, the network node may transmit the client data stream to a linked network node. For example, the network node may transmit the client data stream to a linked network node using a periodic start time derived from an available clock (e.g., as shown in FIG. 6). The network node may transmit the client data stream within pseudo-ethernet packets that include the GMP overhead information that indicates an amount of information that arrived at the first network node within a period associated with the periodic start time. In some aspects, the network node may receive the client data stream, having a data rate as received, from an upstream network node. The network node may transmit the data stream to a downstream network node, including the GMP overhead information that is based on the data rate as received.

The number and arrangement of components shown in FIG. 9 are provided as an example.

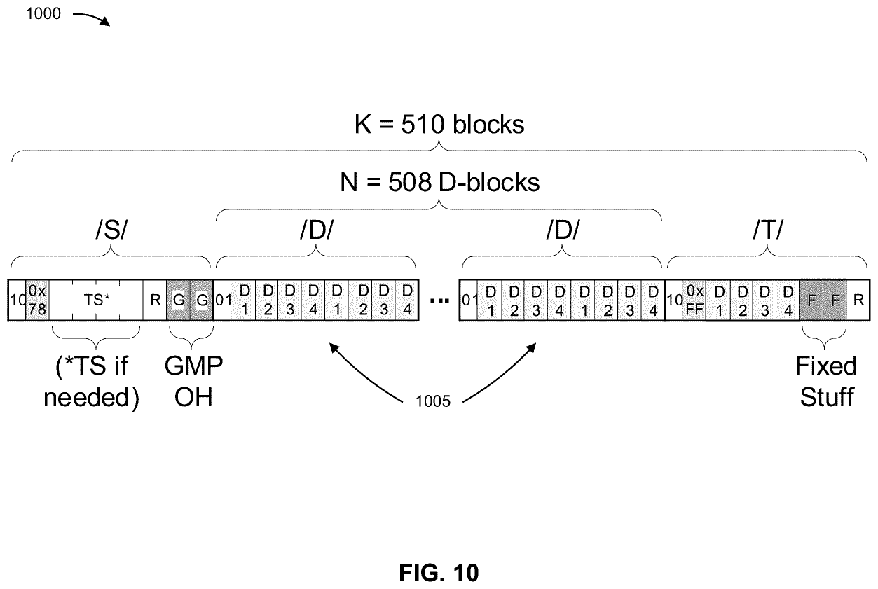

FIG. 10 illustrates a diagram 1000 of an fgCPU communication described herein. Efficient transport of the important 2.048 Mb/s “E1” CBR clients is an application where subdividing (e.g., sharing) an fgCS may be beneficial. Rather than using an entire 10.4 Mb/s fgCS to carry a single E1, the payload area of the fgCS can be subdivided for inserting bytes from multiple (e.g., up to 4) clients on a round-robin basis. As shown in FIG. 10, a /D/ block 1005 may include D1 bytes associated with a first client, D2 bytes associated with a second client, D3 bytes associated with a third client, and D4 bytes associated with a fourth client, as an example. The /T/ block may include “fixed stuff” bytes in data byte positions in the /T/ block so that the number of bytes in the fgCPU data area is divisible by the number of clients. For carrying 4×E1 clients, 4 T7 bytes may be used.

The number and arrangement of components shown in FIG. 10 are provided as an example.

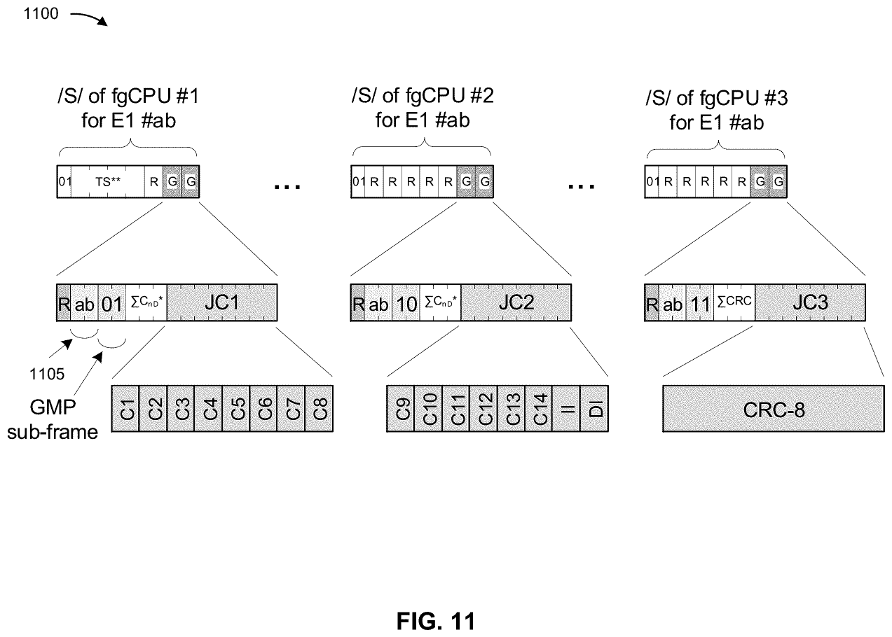

FIG. 11 illustrates a diagram 1100 of fgCPU periodic communications described herein. In context of the examples described in connection with FIG. 10, the fgCPU may include a multi-frame that supports sharing the GMP overhead bytes.

Bits (ab bits 1105) are added to the GMP overhead bytes to indicate the client to which the current GMP overhead pertains. In other words, the ab bits 1105 provide a multi-frame for the GMP overhead use.

The number and arrangement of components shown in FIG. 11 are provided as an example.

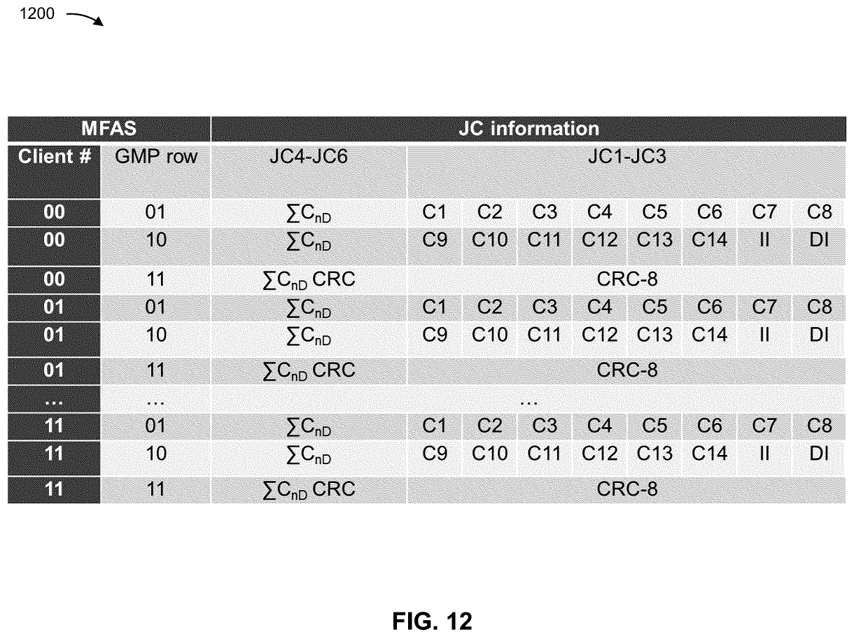

FIG. 12 illustrates a diagram 1200 of examples of JC bytes carried within an fgCPU described herein according to the example of FIG. 11.

In contrast to FIG. 5, where an fgCS or fgCPU set is occupied by a single client, FIG. 11 shows how GMP overhead can be time-shared to allow four different 2 Mb clients to be carried in the same fgCS. The “ab” bit field of FIG. 11 is a binary count to indicate which of the four clients the GMP overhead pertains. The FIG. 12 “client #” column corresponds to the FIG. 11 ab field. In telecommunication terminology, the ab bits thus provide a multi-frame structure. The information in FIG. 12 is just a different way to represent the same as in FIG. 11.

The number and arrangement of components shown in FIG. 12 are provided as an example.

The techniques described herein provide for improvements for carrying CBR clients over an fgMTN network where the fgMTN source and sink nodes share a common ToD reference. The techniques described include one or more of using the combination of GMP overhead information and timestamps to communicate the client clock rate to the sink node (e.g., the GMP overhead specifies the amount of client information arriving at the source node within interval between ToD timestamps), or constructing a pseudo-Ethernet packet (fgCPU) to carry the client information and using GMP to map the client information into the fgCPU). For example, the source node may send timestamp information (when applicable) within the data bytes of the fgCPU /S/ block, or transmit only the difference between the timestamps of successive fgCPU in order to minimize the number of bits that need to be transmitted in each fgCPU.

The source node may use GMP to obtain a fixed fgCPU length. For example, the source node may use an fgCPU length that (e.g., exactly) provides the fgMTN overhead block spacing plus an Idle block for MTN rate adaptation. The source node may use a fixed fgCPU size in order to maintain a fixed GMP word size and timing resolution regardless of the client signal rate.

In some aspects, the source node may use GMP for both mapping and multiplexing CBR client signals into the n×10 Gb/s fgMTN channel. For example, the source node may share the GMP overhead with a multi-frame in order to carry four 2 Mb/s El client signals within the same 10 Gb/s fgMTN channel. In some aspects, the source node may use the data bytes of the fgCPU /D/ blocks and at least 5 bytes of the T7 /T/ block such that the fgCPU can accommodate a bit transparent 10MBASE Ethernet client within a single 10 Gb/s fgMTN channel.

In some aspects, the source node may generate the fgCPU and determining the period between the beginning of successive fgCPU based on using one of a clock derived from the global ToD reference, a clock derived from the network clock reference, or a clock derived from the recovered ingress client clock rate.

In some aspects, the source node may use the common ToD reference at source/sink as the reference for the GMP window rather than a fixed TDM (e.g., OTN) frame. In some aspects, the reference may use a format that sends timestamps or a format that does not require sending timestamps.

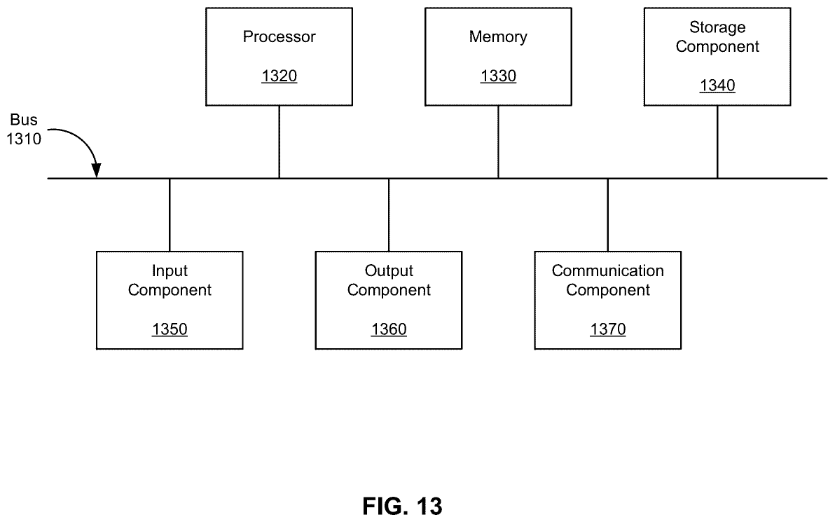

FIG. 13 is a diagram of example components of a device 1300, which may correspond to one or more devices of any of FIGS. 1-12, such as a network node (e.g., a first network node, a second network node, a source network node, a sink network node, or an intermediate node, among other examples). In some implementations, the network node may include one or more devices 1300 and one or more components of device 1300 may include the network node. As shown in FIG. 13, device 1300 may include a bus 1310, a processor 13130, a memory 1330, a storage component 1340, an input component 1350, an output component 1360, and a communication component 1370.

Bus 1310 includes a component that enables wired or wireless communication among the components of device 1300. Processor 1320 includes a central processing unit, a graphics processing unit, a microprocessor, a controller, a microcontroller, a digital signal processor, a field-programmable gate array, an application-specific integrated circuit, or another type of processing component. Processor 1320 is implemented in hardware, firmware, or a combination of hardware and software. In some implementations, processor 1320 includes one or more processors capable of being programmed to perform a function. Memory 1330 includes a random access memory, a read only memory, or another type of memory (e.g., a flash memory, a magnetic memory, or an optical memory).

Storage component 1340 stores information or software related to the operation of device 1300. For example, storage component 1340 may include a hard disk drive, a magnetic disk drive, an optical disk drive, a solid state disk drive, a compact disc, a digital versatile disc, or another type of non-transitory computer-readable medium. Input component 1350 enables device 1300 to receive input, such as user input or sensed inputs. For example, input component 1350 may include a touch screen, a keyboard, a keypad, a mouse, a button, a microphone, a switch, a sensor, a global positioning system component, an accelerometer, a gyroscope, or an actuator. Output component 1360 enables device 1300 to provide output, such as via a display, a speaker, or one or more light-emitting diodes. Communication component 1370 enables device 1300 to communicate with other devices, such as via a wired connection or a wireless connection. For example, communication component 1370 may include a receiver, a transmitter, a transceiver, a modem, a network interface card, or an antenna.

Device 1300 may perform one or more processes described herein. For example, a non-transitory computer-readable medium (e.g., memory 1330 or storage component 1340) may store a set of instructions (e.g., one or more instructions, code, software code, or program code) for execution by processor 1320. Processor 1320 may execute the set of instructions to perform one or more processes described herein. In some implementations, execution of the set of instructions, by one or more processors 1320, causes the one or more processors 1320 or the device 1300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 13 are provided as an example. Device 1300 may include additional components, fewer components, different components, or differently arranged components than those shown in FIG. 13. Additionally, or alternatively, a set of components (e.g., one or more components) of device 1300 may perform one or more functions described as being performed by another set of components of device 1300.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

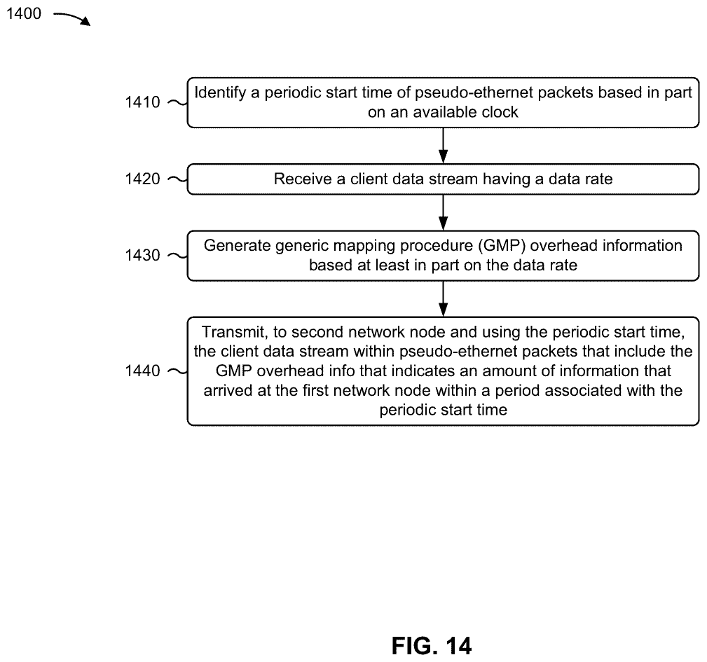

FIG. 14 is a flowchart of an example process 1400 associated with carrying of constant bit rate services via a fine grain metro transport network channel field brief description of the drawings. In some implementations, one or more process blocks of FIG. 14 may be performed by a network node (e.g., a first network node, a second network node, a source network node, a sink network node, or an intermediate node, among other examples). In some implementations, one or more process blocks of FIG. 14 may be performed by another device or a group of devices separate from or including the network node. Additionally, or alternatively, one or more process blocks of FIG. 14 may be performed by one or more components of device 1300, such as processor 1320, memory 1330, storage component 1340, input component 1350, output component 1360, and/or communication component 1370.

As shown in FIG. 14, process 1400 may include identifying a periodic start time of pseudo-ethernet packets based on an available clock (block 1410). For example, the first network node may identify a periodic start time of pseudo-ethernet packets based on an available clock, as described above. For example, as described in connection with FIG. 7, the first network node may identify the periodic start time of fgCPUs.

As further shown in FIG. 14, process 1400 may include receiving a client data stream having a data rate (block 1420). For example, the first network node may receive a client data stream having a data rate, as described above (e.g., as described in connection with FIG. 1, a source node may receive a CBR client signal having a data rate).

As further shown in FIG. 14, process 1400 may include generating generic mapping procedure (GMP) overhead information based at least in part on the data rate (block 1430). For example, the first network node may generate generic mapping procedure (GMP) overhead information based at least in part on the data rate, as described above (e.g., as described in connection with FIG. 1, a source node may generate GMP overhead and time stamp information and insert them into the client signal).

As further shown in FIG. 14, process 1400 may include transmitting, to a second network node and using the periodic start time, the client data stream within pseudo-ethernet packets that include the GMP overhead information that indicates an amount of information that arrived at the first network node within a period associated with the periodic start time (block 1440). For example, the first network node may transmit, to the second network node and using the periodic start time, the client data stream within pseudo-ethernet packets that include the GMP overhead information that indicates an amount of information that arrived at the first network node within a period associated with the periodic start time, as described above. In some aspects, a time stamp may be inserted (e.g., the first network node may insert the time stamp) associated with the start time of a fgCPU, as described in connection with in FIG. 1 where the source node transmits the client signal as with the GMP overhead, timestamp information, and /O/ and /I/ blocks to the intermediate node.

Process 1400 may include additional implementations, such as any single implementation or any combination of implementations described below and/or in connection with one or more other processes described elsewhere herein.

In a first implementation, process 1400 includes identifying a client rate from the GMP overhead information.

In a second implementation, alone or in combination with the first implementation, process 1400 includes transmitting a time stamp associated with the first network node. In some aspects, a time stamp may be inserted (e.g., the first network node may insert the time stamp) associated with the start time of a fgCPU.

In a third implementation, alone or in combination with one or more of the first and second implementations, process 1400 includes inserting one or more bytes into the pseudo-ethernet packets to align timing with the periodic start time.

In a fourth implementation, alone or in combination with one or more of the first through third implementations, the available clock comprises one or more of a clock derived from a global ToD reference, a clock derived from a network clock, a clock derived from a recovered ingress client rate clock.

In a fifth implementation, alone or in combination with one or more of the first through fourth implementations, process 1400 includes receiving a time-of-day (ToD) synchronization message associated with the available clock.

In a sixth implementation, alone or in combination with one or more of the first through fifth implementations, the pseudo-ethernet packets comprises fine grain metro transport network (fgMTN) packets.

In a seventh implementation, alone or in combination with one or more of the first through sixth implementations, client data stream is associated with a constant bit rate (CBR) service.

In an eighth implementation, alone or in combination with one or more of the first through seventh implementations, process 1400 includes inserting the GMP overhead information to pseudo-ethernet packets before receiving a final data packet associated with the pseudo-ethernet packets. In some examples, GMP overhead is inserted into the PEP before enough client data has been received to fill the PEP payload area.

Although FIG. 14 shows example blocks of process 1400, in some implementations, process 1400 may include additional blocks, fewer blocks, different blocks, or differently arranged blocks than those depicted in FIG. 14. Additionally, or alternatively, two or more of the blocks of process 1400 may be performed in parallel.

In some implementations, a method performed by a first global switch box (GSB) includes receiving, via a first plane, a clock signal via a first clock index of a set of clock indices configured to receive clock signals via a clock routing channel. The method includes transitioning the clock signal to a second plane associated with a second clock index. The method includes providing, via the second plane, the clock signal to a second GSB via the second clock index.

In some implementations, a system comprises a memory chip and a first GSB. The first GSB is to receive, via a first plane, a clock signal via a first clock index of a set of clock indices configured to receive clock signals via a clock routing channel. The GSB is to transition the clock signal to a second plane associated with a second clock index. The GSB is to provide, via the second plane, the clock signal to a second GSB via the second clock index.

In some implementations, a computer program product comprises one or more computer readable storage media and program instructions collectively stored on the one or more computer readable storage media. The program instructions comprise program instructions to receive, via a first plane of a GSB, a clock signal via a first clock index of a set of clock indices configured to receive clock signals via a clock routing channel. The program instructions comprise program instructions to transition the clock signal to a second plane associated with a second clock index. The program instructions comprise program instructions to provide, via the second plane, the clock signal to a second GSB via the second clock index.

As used herein, the term “component” is intended to be broadly construed as hardware, firmware, or a combination of hardware and software. It will be apparent that systems or methods described herein may be implemented in different forms of hardware, firmware, or a combination of hardware and software. The actual specialized control hardware or software code used to implement these systems or methods is not limiting of the implementations. Thus, the operation and behavior of the systems or methods are described herein without reference to specific software code-it being understood that software and hardware can be used to implement the systems or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims or disclosed in the specification, these combinations are not intended to limit the disclosure of various implementations. In fact, many of these features may be combined in ways not specifically recited in the claims or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “or,” unless explicitly stated otherwise (e.g., if used in combination with “either” or “only one of”).

What is claimed is:

1. A method performed by a first network node, the method comprising:
identifying a periodic start time of pseudo-ethernet packets based on an available clock;
receiving a client data stream having a data rate;
generating generic mapping procedure (GMP) overhead information based at least in part on the data rate; and
transmitting, to a second network node and using the periodic start time, the client data stream within pseudo-ethernet packets that include the GMP overhead information that indicates an amount of information that arrived at the first network node within a period associated with the periodic start time.

2. The method of claim 1, further comprising:
identifying a client rate from the GMP overhead information.

3. The method of claim 1, further comprising:
transmitting a time stamp associated with the first network node.

4. The method of claim 1, further comprising:
inserting one or more bytes into the pseudo-ethernet packets to align timing with the periodic start time.

5. The method of claim 1, wherein the available clock comprises one or more of:
a clock derived from a global ToD reference,
a clock derived from a network clock, or
a clock derived from a recovered ingress client rate clock.

6. The method of claim 1, further comprising:
receiving a time-of-day (ToD) synchronization message associated with the available clock.

7. The method of claim 1, wherein the pseudo-ethernet packets comprises fine grain metro transport network (fgMTN) packets.

8. The method of claim 1, wherein client data stream is associated with a constant bit rate (CBR) service.

9. The method of claim 1, further comprising:
inserting the GMP overhead information to pseudo-ethernet packets before receiving a final data packet associated with the pseudo-ethernet packets.

10. A system comprising:
one or more memories of a first network node; and
one or more processors, of a first network node and coupled to the one or more memories, to:
identify a periodic start time of pseudo-ethernet packets based on an available clock;
receive a client data stream having a data rate;
generate generic mapping procedure (GMP) overhead information based at least in part on the data rate; and
transmit, to a second network node and using the periodic start time, the client data stream within pseudo-ethernet packets that include the GMP overhead information.

11. The system of claim 10, wherein the available clock comprises one or more of:
a clock derived from a global ToD reference,
a clock derived from a network clock, or
a clock derived from a recovered ingress client rate clock.

12. The system of claim 10, wherein one or more processors are to:
receive a time-of-day (ToD) synchronization message associated with the available clock.

13. The system of claim 10, wherein the pseudo-ethernet packets comprises fine grain metro transport network (fgMTN) packets.

14. The system of claim 10, wherein client data stream is associated with a constant bit rate (CBR) service.

15. The system of claim 10, wherein one or more processors are to:
insert the GMP overhead information to pseudo-ethernet packets before receiving a final data packet associated with the pseudo-ethernet packets.

16. A computer program product comprising:
one or more computer readable storage media, and program instructions collectively stored on the one or more computer readable storage media, the program instructions comprising:
program instructions to identify a periodic start time of pseudo-ethernet packets based on an available clock;
program instructions to receive a client data stream having a data rate;
program instructions to generate generic mapping procedure (GMP) overhead information based at least in part on the data rate; and
program instruction to transmit, to a second network node and using the periodic start time, the client data stream within pseudo-ethernet packets that include the GMP overhead information that indicates an amount of information that arrived at a first network node within a period associated with the periodic start time.

17. The computer program product of claim 16, wherein the program instructions comprise:
program instructions to identify a client rate from the GMP overhead information.

18. The computer program product of claim 16, wherein the program instructions comprise:
program instructions to transmit a time stamp associated with the first network node.

19. The computer program product of claim 16, wherein the program instructions comprise:
insert one or more bytes into the pseudo-ethernet packets to align timing with the periodic start time.

20. The computer program product of claim 16, wherein the available clock comprises one or more of:
a clock derived from a global ToD reference,
a clock derived from a network clock, or
a clock derived from a recovered ingress client rate clock.
